(19) United States
(12) Patent Application Publication
(10) Pub. No.: US 2011/0044057 A1
(43) Pub. Date: Feb. 24, 2011

(54) Fresnel Lens Sheet And Luminaire Using The Same

(76) Inventor: Onn Fah FOO, Kowloon (HK)

Correspondence Address: KEVIN J. MCNEELY, ESQ., 5335 WISCONSON AVENUE, NW, SUITE 440, WASHINGTON, DC, 20015, US

(21) Appl. No.: 12/860,931

(22) Filed: Aug. 22, 2010

(30) Foreign Application Priority Data
Aug. 21, 2009 (EP) 09252040.2

(51) Int. Cl. F21V 5/02; G02B 3/08

(52) U.S. Cl. 362/311.02; 359/742; 362/311.06

(57) ABSTRACT

The present invention provides A Fresnel lens sheet for use in a luminaire, comprising a transparent sheet having a first surface on one side which is substantially planar and a second surface on the other side; and a Fresnel lens part containing a plurality of concentric convex prisms formed on the second surface, each of the convex prisms having a cross-section of substantially triangular structure, wherein the substantially triangular structure has an apex formed by joining a first curved portion and a second curved portion, and a base; and this triangular structure has a ratio of a radius of the second curved portion to a base width ranging from 0.1 to 0.5. The invention also provides a luminaire utilizing the Fresnel lens sheet of the invention.

### CROSS REFERENCE TO RELATED APPLICATIONS

This utility patent application claims priority to European Patent Application No. 09252040.2 filed on Aug. 21, 2009, which is incorporated by reference herein.

### FIELD OF THE INVENTION

This invention relates generally to an improvement in a Fresnel lens utilized in the field of lighting fixtures, and more particularly, to a Fresnel lens sheet which is capable of concentrating a beam of light within a relatively small angle, and achieving highly efficient uniform lighting and more effective luminous flux, and to a luminaire using the Fresnel lens sheet as a light transmission piece.

### BACKGROUND

Lamps having a combination of a light source and a Fresnel lens are commonly found in the art for gathering, focusing and directing light from the light source. The most common kind of the lamps is that the light source is disposed to face the Fresnel lens to allow the Fresnel lens to redirect the light emitting from the light source for the purpose of concentrating the light or spreading out the light.

In applications requiring high intensity light, such as downlights and spotlights, a Fresnel lens sheet is very useful to concentrate light to a relatively small zone. The configuration of a conventional Fresnel lens sheet 100 utilized in a lamp as a light transmission piece is illustrated in FIG. 1. As illustrated, the Fresnel lens sheet 100 consists of a plurality of concentric rings of segmental lenses 110, and each of the segmental lenses 110 has a cross section of substantially triangular structure. The triangular structure is generally in a shape of a right triangle having a hypotenuse and an acute apex angle. FIG. 2 illustrates graphically illumination distribution produced by this conventional Fresnel lens sheet. A portion of the light emitting from the light source (not shown) is refracted to pass through the Fresnel lens sheet generally along the hypotenuses of the right triangles to define a lighting zone having a coverage Z1. As can be seen, the illumination is generally circularly-distributed and has less distribution in the central part of the zone coverage Z1.

FIG. 3 clearly shows that another portion of the light emitting from the light source 150 is reflected back by a planar surface of the Fresnel lens sheet and cannot be refracted to pass through the Fresnel lens sheet, and a further portion of the light is reflected and then refracted to pass through the sheet. As illustrated, the light emitting from the light source 150 is directed to the Fresnel lens sheet 100 from various directions, and a large portion of the light is reflected to travel in the direction opposite the Fresnel lens sheet, with the result of loss of this portion of light. In this figure, the lines in bold represent the portion of the light which is refracted directly to pass through the Fresnel lens sheet. While the lines in thin represent the portion of the light which is first reflected and then refracted to pass through the Fresnel lens sheet, this portion of the light is less illuminous than the portion of the light which is refracted directly.

Therefore, there is a need for a Fresnel lens sheet utilized in a lamp for better concentrating a beam of light having a relatively small beam angle and for intensifying the illuminance in the central part of the illumination zone. There is also a need for a Fresnel lens sheet that is capable of reducing the loss of light energy during the process of reflection.

### SUMMARY

The present invention has been developed to fulfill the needs noted above and therefore has a principle object of the provision of a Fresnel lens sheet utilized in a luminaire, which can concentrate a beam of light with a relatively small beam angle.

Another object of the invention is to provide a Fresnel lens sheet utilized in a luminaire, which can reduce the loss of light energy during the process of reflection.

These and other objects and advantages of the invention are satisfied by providing a Fresnel lens sheet for use in a luminaire, comprising:

a transparent sheet having a first surface on one side which is substantially planar, and a second surface on the other side; and

a Fresnel lens part containing a plurality of concentric convex prisms formed on the second surface, each of the convex prisms having a cross-section of substantially triangular structure,

wherein the substantially triangular structure has an apex formed by joining a first curved portion and a second curved portion, and a base; and this triangular structure has a ratio of a radius of the second curved portion to a base width ranging from 0.1 to 0.5.

In one preferred embodiment of the invention, the above ratio ranges from 0.3 to 0.5, and the first and second curved portions are formed to have rounded configuration.

Another aspect of the invention is to provide a luminaire comprising:

a Fresnel lens sheet according to the invention;

a housing having an opening side, wherein the Fresnel lens sheet is disposed in the vicinity of the opening side; and

at least one light source disposed in the housing in a manner that the light source is facing the first surface of the Fresnel lens sheet to generate light toward to the Fresnel lens sheet, allowing passage of the light therethrough.

According to the invention, the luminaire can be used in many types of luminaries, such as incandescent lamps, fluorescent lamps, downlights, spotlights, automobile headlamps, traffic lights or decorative lights.

Preferably, the light source in the luminaire is a light emitting diode.

In contrast to the Fresnel lens sheet available in the prior art, the Fresnel lens sheet of the invention is configured to have a plurality of concentric convex prisms, each of the prisms having a cross-section of substantially triangular structure, and the triangular structure is characterized by an apex formed by joining a first curved portion and a second curved portion, and by a ratio of a radius of the second curved portion to a base width ranging from 0.1 to 0.5. It has been already found that within this range of the ratio, a beam of light that passes through the Fresnel lens sheet is concentrated to have a relatively small beam angle and a relatively centrally-distribution illumination. Also, the Fresnel lens sheet of the invention allows for redirecting a majority of the light to pass therethrough to reduce the loss of light energy.

To have a better understanding of the invention reference is made to the following detailed description of the invention and embodiments thereof in conjunction with the accompanying drawings.

### BRIEF DESCRIPTION OF THE DRAWINGS

FIG. 1 is a sectional view of a Fresnel lens sheet available in the prior art.

FIG. 2 is a view showing schematics of light refraction of the Fresnel lens sheet of FIG. 1.

FIG. 3 is a view showing the illumination pattern of the Fresnel lens sheet of FIG. 1.

FIG. 4 is a perspective view of a Fresnel lens sheet constructed according to a preferred embodiment of the present invention.

FIG. 5 is a top view of the Fresnel lens sheet of FIG. 4.

FIG. 6 is a cross-sectional view taken along line A-A of FIG. 4.

FIG. 7 is an enlarged view of Section B of FIG. 6.

FIG. 8 is a view showing schematics of light refraction of the Fresnel lens sheet of FIG. 4.

FIG. 9 is a view showing the illumination pattern of the Fresnel lens sheet of FIG. 4.

FIG. 10 is a perspective view of an exemplary luminaire using the Fresnel lens sheet of the invention.

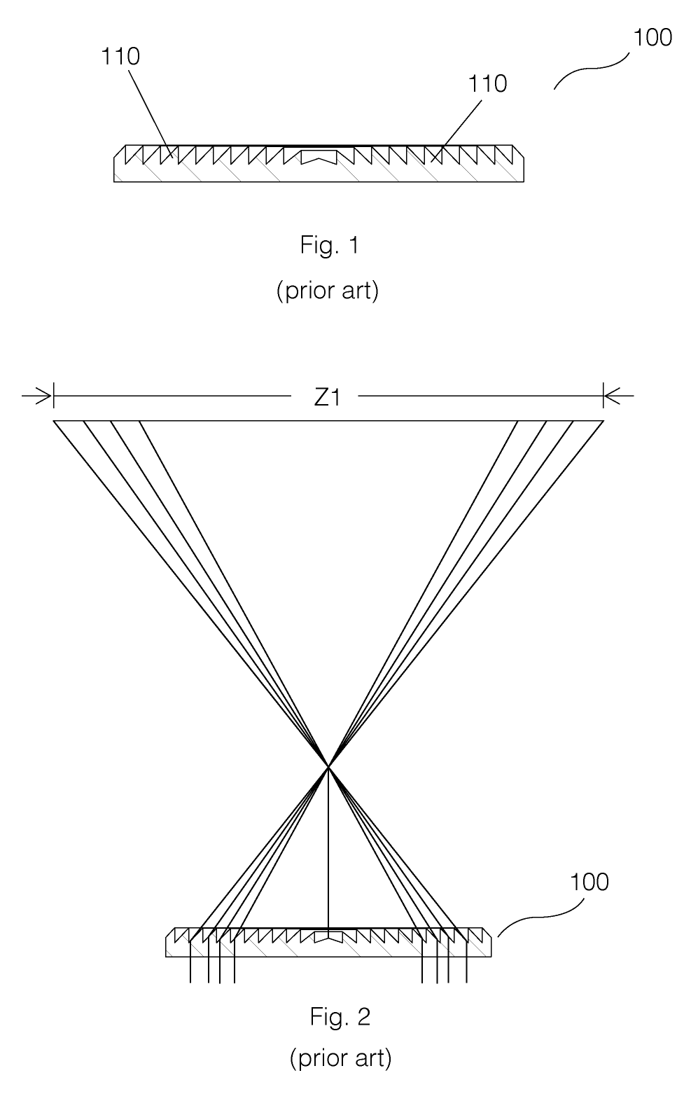

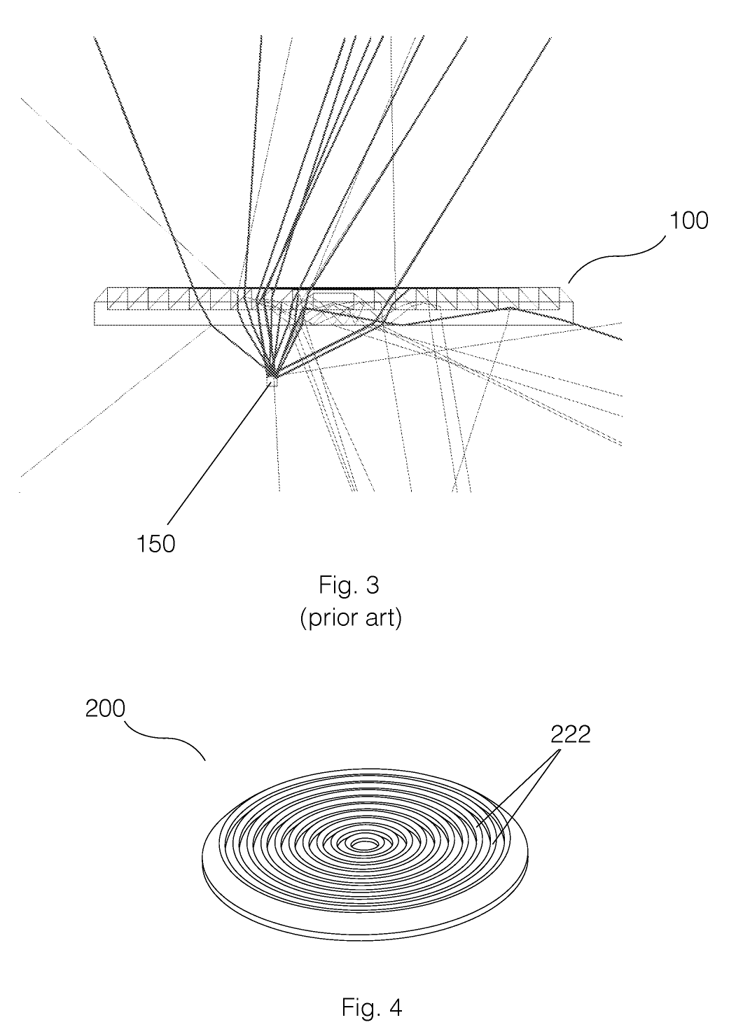

In the various figures of the drawings, like reference numbers are used to designate like parts.

### DETAILED DESCRIPTION

While this invention is illustrated and described in preferred embodiments, the Fresnel lens sheet may be produced in many different configurations, sizes, forms and materials.

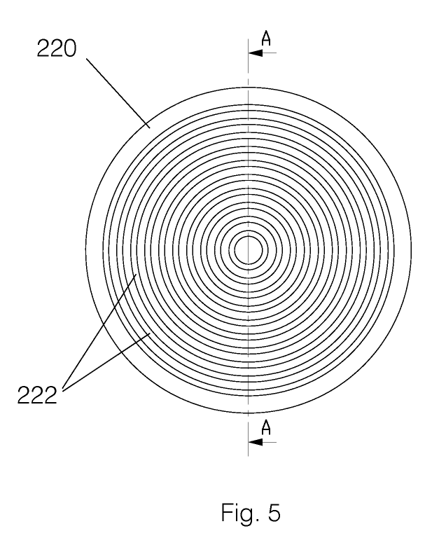

Referring now to the drawings, FIGS. 4 to 9 provide a Fresnel lens sheet 200 constructed consistent with a preferred embodiment of the present invention. In this embodiment, the Fresnel lens sheet 200 comprises a transparent sheet 210 and a Fresnel lens part 220. The Fresnel lens sheet 200 may be formed with a material selected from glass, plastics, polyolefins or organic glasses.

The transparent sheet 210 has a first surface 212 which is substantially planar, and a second surface 214 opposite the first surface 212. Preferably, the transparent sheet 210 has a height in the range from 1 mm to 10 mm.

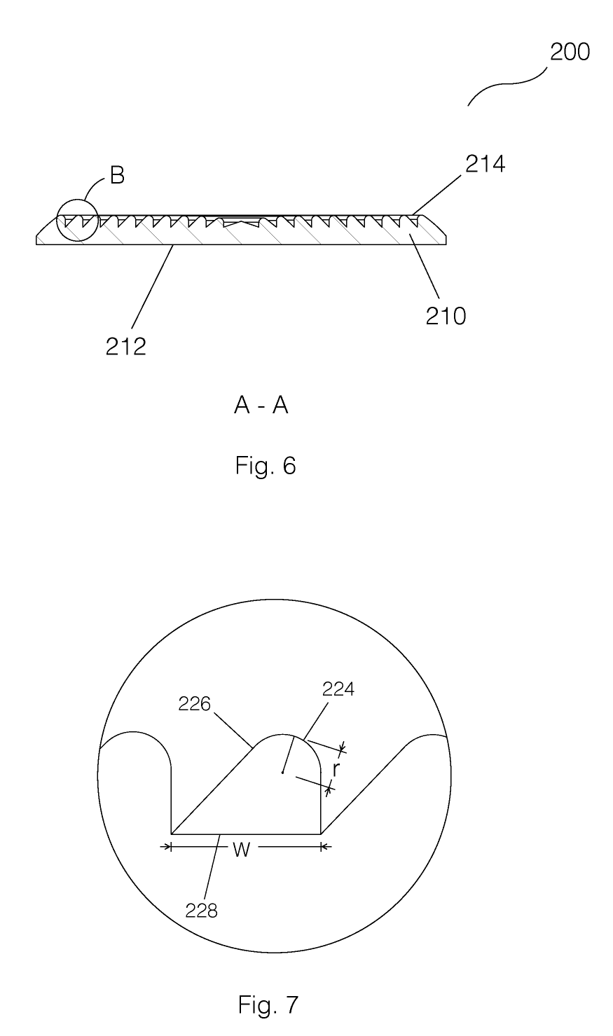

The Fresnel lens part 220 is formed on the second surface 214 of the transparent sheet 210. The Fresnel lens part 220 consists of a plurality of concentric convex prisms 222, as shown in FIGS. 4 and 5. FIG. 6 illustrates that each of the convex prisms 222 has a cross-section of substantially triangular structure. This substantially triangular structure has a base 228 of width “w”, a first rounded portion 226 and a second rounded portion 224, both of the two rounded portions 226, 224 are joined to define an apex of the substantially triangular structure. In particular, the substantially triangular structure is configured to have a ratio of a radius “r” of the second rounded portion 224 to the base width “w” ranging from 0.1 to 0.5, preferably ranging from 0.3 to 0.5, as shown in FIG. 7. It would be apparent to a person skilled in the art that the Fresnel lens sheet 200 may be made by thermo-molding a material selected from glass, plastics or polyolefins or through any methods known in the art, which will not be detailed herein.

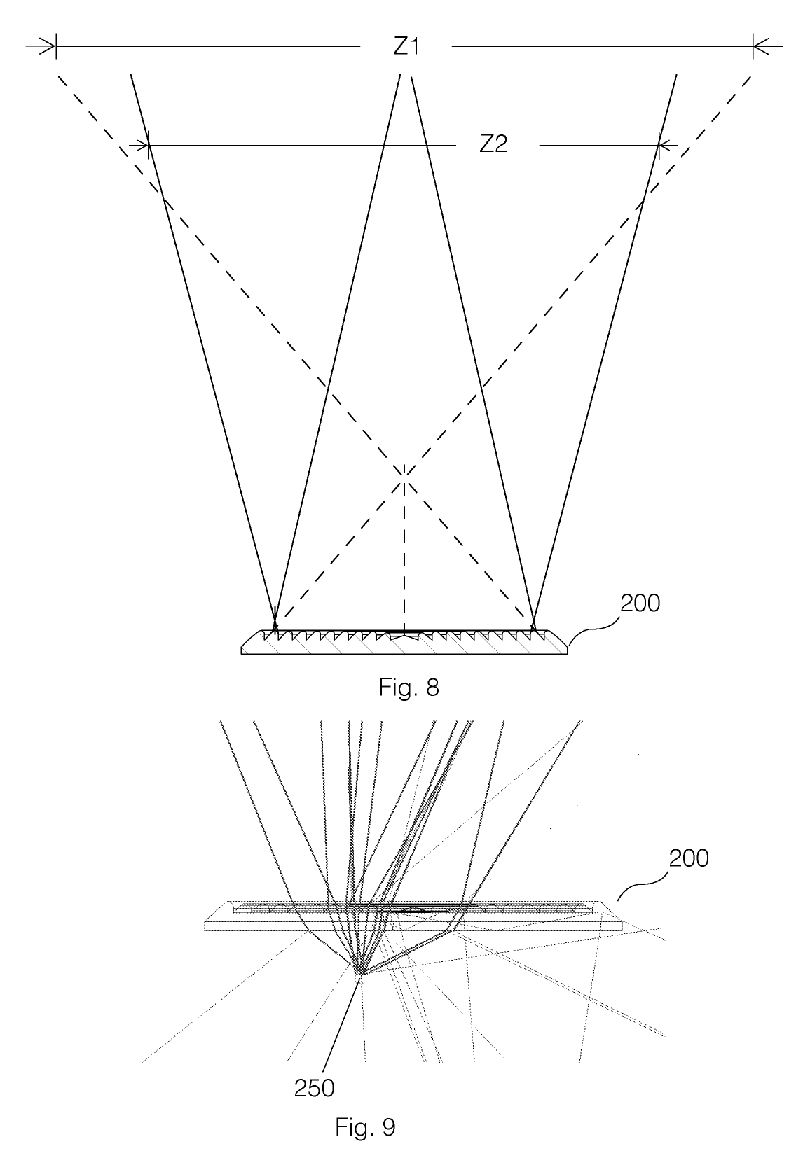

FIG. 8 illustrates a view showing schematics of light refraction of the Fresnel lens sheet 200. As illustrated, the beam of the light from the light source (not shown) is emitted within a small angle relative to the beam angle of the commonly available Fresnel lens sheet which is also shown in broken line in this figure. This narrow-angle light, which passes through the first planar surface 212 and the Fresnel lens part 220, tends to fall into a lighting zone having a coverage Z2 in which a relatively large portion of the light is distributed in the central part of the lighting zone coverage Z2.

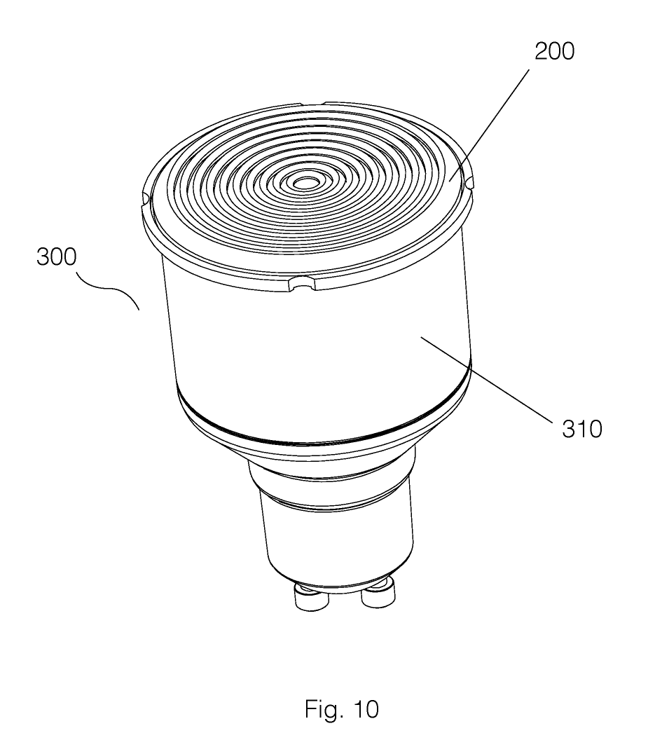

Reference is now made to FIG. 9. This figure illustrates the illumination pattern of the Fresnel lens sheet 200 with the second rounded portion 224 having a radius of 0.75 mm when the base width is 2 mm, namely, the ratio of the radius “r” to the base with “w” is 0.375. As illustrated, the light emitting from the light source 250 reaches the first planar surface 212 from various directions, with only a small portion of the light being reflected and exhausted during the process of reflection, and a very smaller portion of the light is first reflected and then refracted to pass through the Fresnel lens sheet 200 when compared to the illumination pattern as shown in FIG. 3, while a relatively large portion of the light is refracted directly to pass through the Fresnel lens sheet 200 to exit the sheet 200. As discussed above, this portion of the light in bold is more illuminous than the portion of the light in thin which is reflected and then refracted to exit the Fresnel lens sheet 200. Therefore, the overall light through the Fresnel lens sheet 200 has an improved light intensity and a higher luminous flux.

It has been found that the first rounded portion 226 of the Fresnel lens part 220 serves to intensify and concentrate the light emitting from the light source 250, and the second rounded portion 224 can narrow the angle of refraction down and further concentrate and redirect the light from the first rounded portion 226 such that the light, which exits from the second rounded portion 224, is inclined to be distributed centrally, producing the illumination pattern shown in FIG. 8. As a result, a uniform light intensity and a centrally-distributed illumination are possible.

The invention also provides a luminaire 300 comprising the Fresnel lens sheet 200 described above. FIG. 10 illustrates a example of this luminaire 300. In particular, the luminaire 300 comprises the Fresnel lens sheet 200; a housing 310 having an opening side, wherein the Fresnel lens sheet 200 is disposed in the vicinity of the opening side; and at least one light source (not shown) disposed in the housing in a manner that the light source is facing the first surface of the Fresnel lens sheet to generate light toward to the Fresnel lens sheet, allowing passage of the light therethrough.

It would be understood that the luminaire of the invention may be any type of a lighting fixture, including but not limited to incandescent lamps, fluorescent lamps, downlights, spotlights, automobile headlamps, traffic lights and decorative lights. The light source can be a light emitting diode or any other types of light sources well known in the art.

### Example

A plurality of the Fresnel lens sheets constructed according to the invention were tested for their illumination characteristics. In these tests, the base width “w” is set to be 2 mm, and the radius “r” of the second rounded portion of the Fresnel lens part is varied in the plurality of the Fresnel lens sheets.

The results obtained from these tests are given in the following table.

TABLE 1
Test results of illumination characteristics of Fresnel lens sheets of the invention

| | | | | | Ratio of 120° |
|---|---|---|---|---|---|
| | | | 180° | 120° | cumulate |
| | | | cumulate | cumulate | luminous flux to |
| Type of Fresnel | Beam | Maximum | luminous | luminous | 180° cumulate |
| lens sheet | angle | intensity | flux | flux | luminous flux |
| Fresnel lens sheet | 95° | 112.26 cd | 263.19 lm | 210.81 lm | 0.801 |
| without the second | | | | | |
| rounded portion | | | | | |
| Fresnel lens sheet | 93° | 118.99 cd | 270.79 lm | 224.81 lm | 0.830 |
| having the second | | | | | |
| rounded portion | | | | | |
| (r = 0.5 mm) | | | | | |
| Fresnel lens sheet | 89° | 142.22 cd | 276.52 lm | 234.56 lm | 0.848 |
| having the second | | | | | |
| rounded portion | | | | | |
| (r = 0.6 mm) | | | | | |
| Fresnel lens sheet | 87° | 151.29 cd | 277.69 lm | 240.74 lm | 0.867 |
| having the second | | | | | |
| rounded portion | | | | | |
| (r = 0.75 mm) | | | | | |
| Fresnel lens sheet | 90° | 135.14 cd | 285.72 lm | 242.3 lm | 0.848 |
| having the second | | | | | |
| rounded portion | | | | | |
| (r = 0.8 mm) | | | | | |
| Fresnel lens sheet | 90° | 133.55 cd | 285.72 lm | 242.3 lm | 0.848 |
| having the second | | | | | |
| rounded portion | | | | | |
| (r = 1.0 mm) | | | | | |

The results revealed that the Fresnel lens sheets of the invention have a light-focusing pattern and a relatively centrally-distributed illumination when compared with the Fresnel lens sheet available in the prior art, because a majority of the light from the light source is emitted through the Fresnel lens sheets of the invention within a small beam angle. Among these Fresnel lens sheets, the Fresnel lens sheet having the second rounded portion with r=0.75 mm, namely, the ratio of the radius of the second rounded portion to the base width is 0.375, has produced the best light pattern.

The invention thus provides a Fresnel lens sheet for use in a luminaire which is able to concentrate and redirect the light from the light source so as to cast a substantially centrally-distributed illumination, with the result of improved light efficiency and higher light intensity. This is because the Fresnel lens sheet of the invention is designed to form a Fresnel lens part which has a rounded apex defined by first and second rounded portions with a ratio of a radius of the second rounded portion to the base width being 0.1 to 0.5.

While the embodiments described herein are intended as an exemplary Fresnel lens sheet, it will be appreciated by those skilled in the art that the present invention is not limited to the embodiments illustrated. Those skilled in the art will envision many other possible variations and modifications by means of the skilled person's common knowledge without departing from the scope of the invention, however, such variations and modifications should fall into the scope of this invention.

What is claimed is:

1. A Fresnel lens sheet for use in a luminaire, comprising:
a transparent sheet having a first surface on one side which is substantially planar, and a second surface on the other side; and
a Fresnel lens part containing a plurality of concentric convex prisms formed on the second surface, each of the convex prisms having a cross-section of substantially triangular structure,
wherein the substantially triangular structure has an apex formed by joining a first curved portion and a second curved portion, and a base; and this triangular structure has a ratio of a radius of the second curved portion to a base width ranging from 0.1 to 0.5.

2. The Fresnel lens sheet as claimed in claim 1, wherein the ratio ranges from 0.3 to 0.5.

3. The Fresnel lens sheet as claimed in claim 1, wherein the first and second curved portions are formed to have rounded configuration.

4. The Fresnel lens sheet as claimed in claim 1, wherein the Fresnel lens sheet is formed with a material selected from glass, plastic, polyolefin or organic glass.

5. A luminaire comprising:
a Fresnel lens sheet as claimed in claim 1;
a housing having an opening side, wherein the Fresnel lens sheet is disposed in the vicinity of the opening side; and
at least one light source disposed in the housing in a manner that the light source is facing the first surface of the Fresnel lens sheet to generate light toward to the Fresnel lens sheet, allowing passage of the light therethrough.

6. The luminaire as claimed in claim 5, wherein the luminaire is selected from the group consisting of incandescent lamps, fluorescent lamps, downlights, spotlights, automobile headlamps, traffic lights and decorative lights.

7. The luminaire as claimed in claim 5, wherein the light source is a light emitting diode.
